(19) United States
(12) Patent Application Publication
(10) Pub. No.: US 2021/0288561 A1
(43) Pub. Date: Sep. 16, 2021

(54) MOTOR DEVICE

(71) Applicant: DENSO CORPORATION, Kariya-city (JP)

(72) Inventor: Yoshiki KATO, Kariya-city (JP)

(21) Appl. No.: 17/196,198

(22) Filed: Mar. 9, 2021

(30) Foreign Application Priority Data
Mar. 12, 2020 (JP) 2020-043345

(51) Int. Cl. H02K 11/33; H02K 3/52; H02K 5/22; H02K 11/215; H02K 21/16; F01L 1/344; G01D 5/14; G01B 7/30

(52) U.S. Cl. CPC H02K 11/33; H02K 3/522; H02K 5/225; H02K 11/215; H02K 21/16; F01L 2820/042; G01D 5/145; G01B 7/30; H02K 2211/03; F01L 2820/041; F01L 1/344

(57) ABSTRACT

A motor device includes a motor and a drive device. The motor includes a housing shaped in a bottomed cylinder shape, a stator and a rotor held by the housing, and a sensor magnet attached to a rotor surface on an upper surface of the rotor. The drive device includes a wiring board facing the sensor magnet, an electronic component mounted on the wiring board, a Hall element mounted on the wiring board to face the sensor magnet, and a sealing resin body sealing the wiring board. The sealing resin body includes, as a positioner for positioning the sealing resin body and the housing in a radial direction and in a circumferential direction centering on a motor shaft axis, an inlay wall surface and a fixing part.

### CROSS REFERENCE TO RELATED APPLICATION

The present application is based on and claims the benefit of priority of Japanese Patent Application No. 2020-043345, filed on Mar. 12, 2020, the disclosure of which is incorporated herein by reference.

### TECHNICAL FIELD

The present disclosure generally relates to a motor device.

### BACKGROUND INFORMATION

A motor device may have an integral electromechanical structure including a motor and a motor drive device.

### SUMMARY

It is an object of the present disclosure to provide a motor device that can accurately detect a rotation angle of a motor.

Reference numerals in parentheses described in claims and this section exemplarily show corresponding relationships with parts of embodiments to be described later and are not intended to limit technical scopes.

The objects, features, and advantages disclosed in this specification will become apparent by referring to following detailed descriptions and accompanying drawings.

### BRIEF DESCRIPTION OF THE DRAWINGS

Objects, features, and advantages of the present disclosure will become more apparent from the following detailed description made with reference to the accompanying drawings, in which:

FIG. 1 is a cross-sectional view of cutaway I-I in FIG. 2, and shows a schematic configuration of a valve timing adjusting device including a motor device according to a first embodiment;

FIG. 2 is a plan view showing the motor device and three cutaway lines: line I-I, line IV-IV, and line V-V;

FIG. 3 is an exploded perspective view showing the motor device;

FIG. 4 is a cross-sectional view along the cutaway line IV-IV of FIG. 2;

FIG. 5 is a cross-sectional view along the cutaway line V-V of FIG. 2;

FIG. 6 is a plan view of a motor device with a cover omitted therefrom;

FIG. 7 is a perspective view of a drive device as seen from a motor side;

FIG. 8 is a plan view of the drive device as seen from the motor side; and

FIG. 9 is a plan view illustrating a modification.

### DETAILED DESCRIPTION

Hereinafter, embodiments will be described with reference to the drawings. Throughout descriptions of the embodiments, functionally and/or structurally corresponding parts and/or associated parts are provided with the same reference symbols. For corresponding parts and/or associated parts, additional explanations can be made in the description of other embodiments in addition to the description of the base embodiment.

### First Embodiment

The motor device according to the present embodiment is applied to, for example, a valve timing adjusting device for a vehicle. First, a schematic configuration of the valve timing adjusting device will be described.

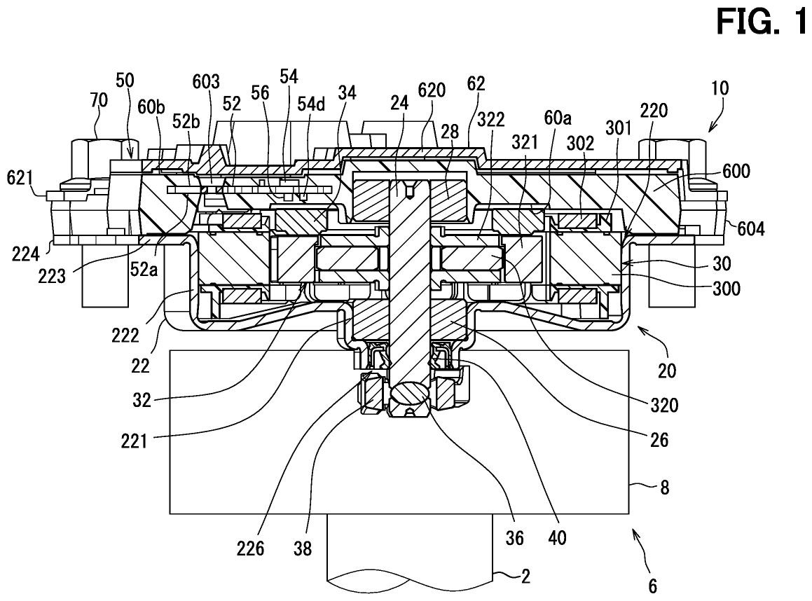

### Valve Timing Adjusting Device, FIGS. 1, 2, 6

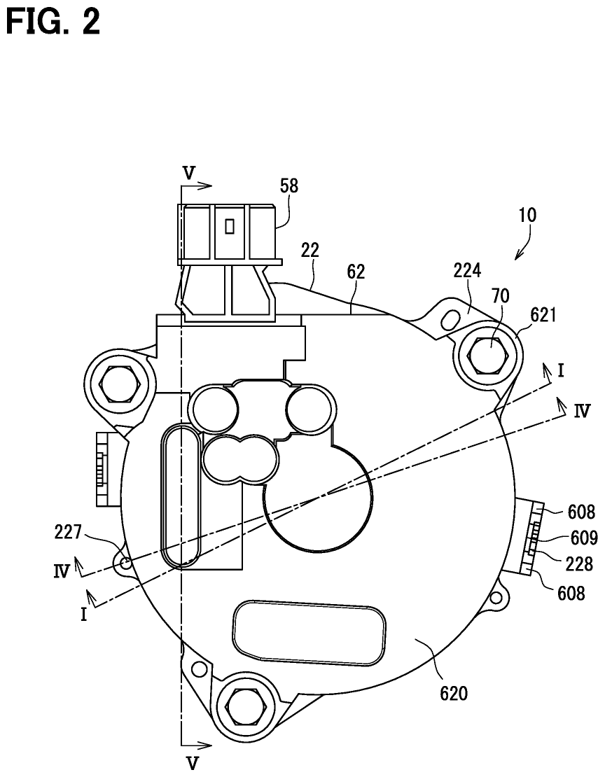

FIG. 1 is a cross-sectional view of the valve timing adjusting device, taken along the line I-I in FIG. 2. A valve timing adjusting device 6 shown in FIG. 1 is provided in a transmission system that transmits a crank torque from a crankshaft (not shown) of an internal-combustion engine to a camshaft 2 in a vehicle. The camshaft 2 opens and closes a valve of the internal-combustion engine, for example, an intake valve (not shown) by transmitting the crank torque. The valve timing adjusting device 6 controls the valve timing of an intake valve by the motor 20.

The valve timing adjusting device 6 includes a phase adjusting mechanism 8 and a motor device 10. The phase adjusting mechanism 8 is connected to the camshaft 2. In FIG. 1, the phase adjusting mechanism 8 is shown in a simplified manner. The basic configuration of the phase adjusting mechanism 8 is the same as the configuration described in, for example, JP 2015-203392 A. Regarding the phase adjusting mechanism, the contents described in the above publications can be incorporated by reference.

The drive device 50 calculates a rotation phase based on detection signals from a crank angle sensor and a cam angle sensor, and controls the energization of the motor 20 according to the calculation result. As a result, the phase adjusting mechanism 8 adjusts the rotation phase according to the rotation of the motor 20 and controls the valve timing.

### Motor Device

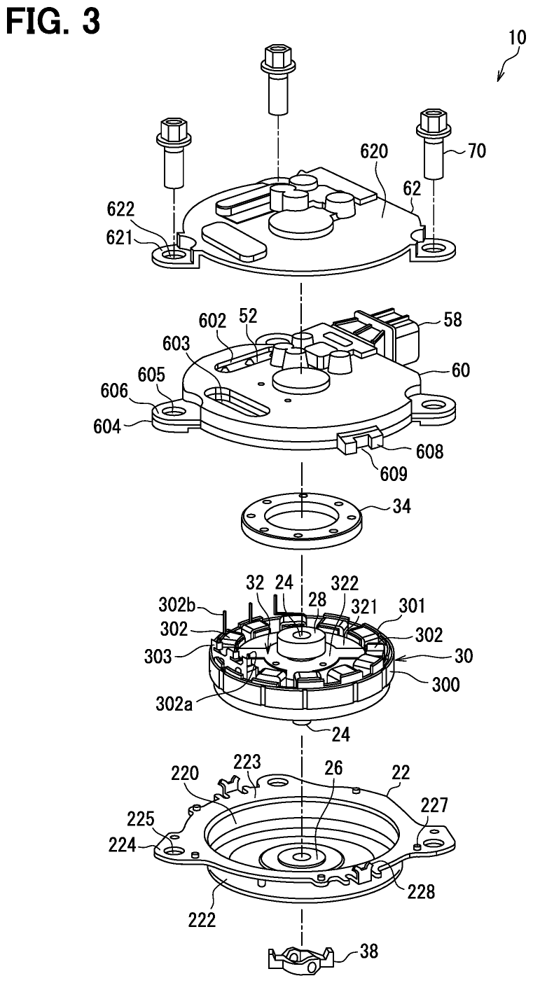

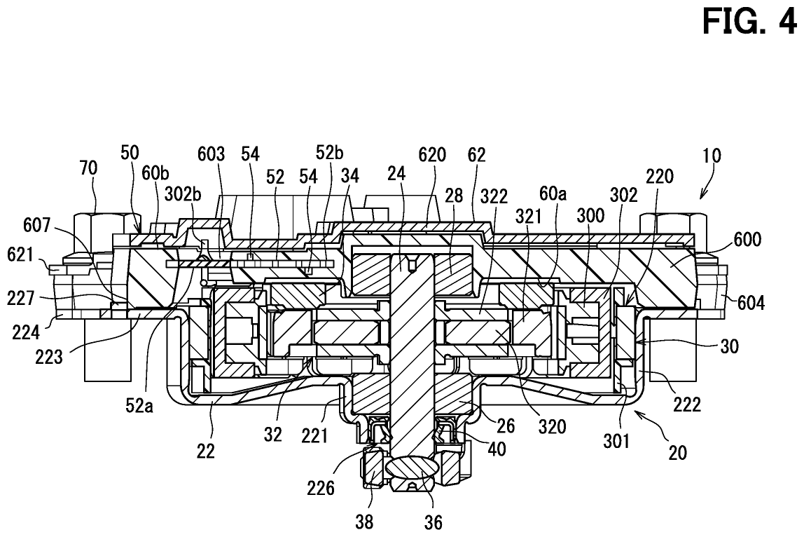

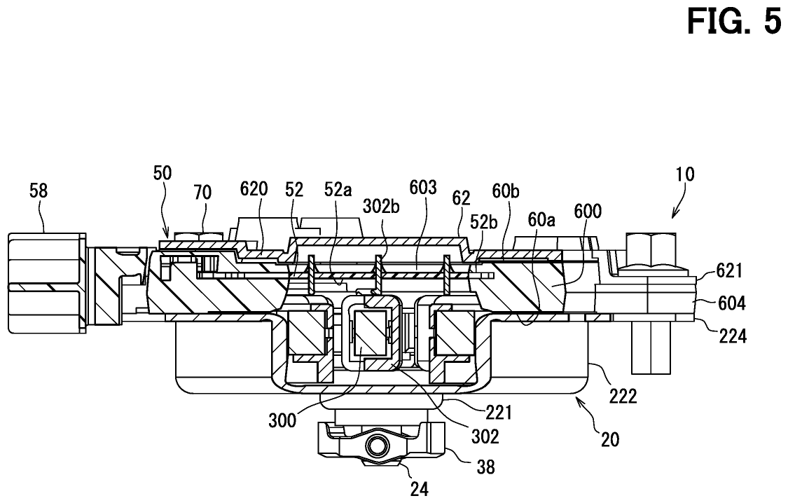

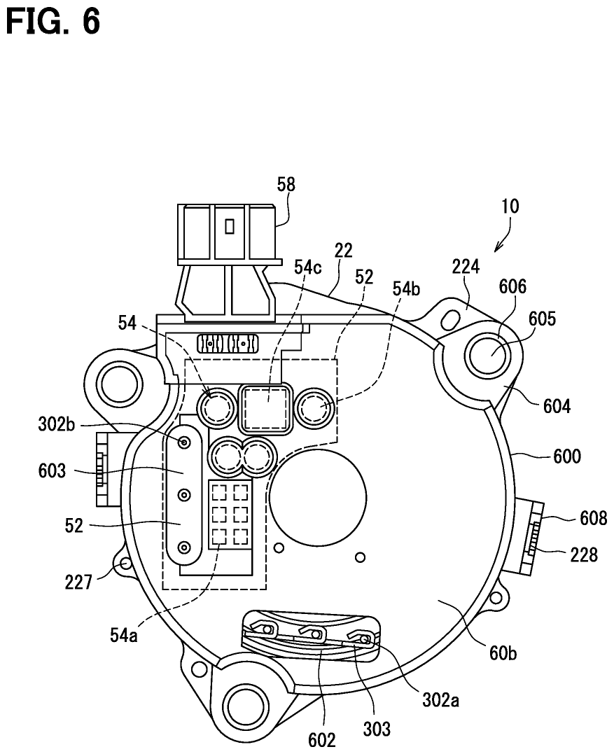

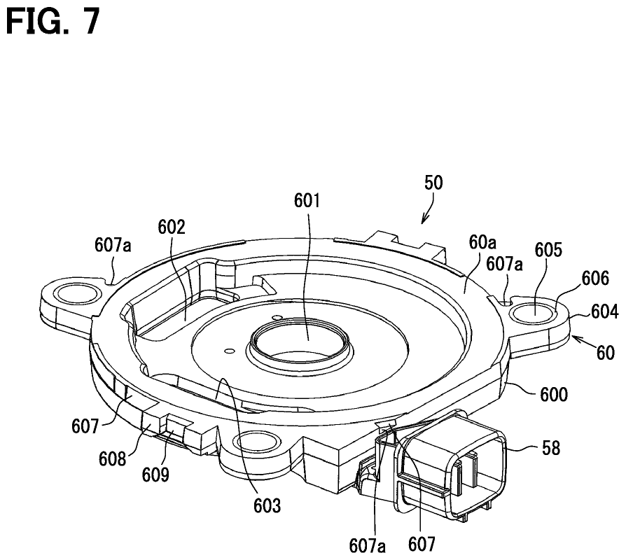

Next, a schematic configuration of the motor device 10 will be described with reference to FIGS. 1 to 7. FIG. 1 is a cross-sectional view of the valve timing adjusting device corresponding to the line I-I in FIG. 2. FIG. 2 is a plan view of the motor device 10 as seen from a drive device 50 side. FIG. 3 is an exploded perspective view of the motor device 10. FIG. 4 is a cross-sectional view of the motor device 10 along the line IV-IV in FIG. 2. FIG. 5 is a cross-sectional view of the motor device 10 along the line V-V of FIG. 2. FIG. 6 is a plan view of the motor device 10 seen from a cover 62 side. In FIG. 6, for convenience, a cover 62 is omitted, and, from among elements of the motor 20 exposed from a through hole 602, only the elements at a proximity of the terminal 303 are shown. FIG. 7 is a perspective view of the drive device 50 seen from the motor 20 side. In FIG. 7, the cover 62 is omitted for convenience.

Hereinafter, the extending direction of the motor shaft 24 may simply be referred to as an axial direction, and extends in a vertical direction in FIG. 1. The center of the motor shaft 24 corresponds to a rotation axis of the motor 20. Therefore, the axial direction corresponds to the direction along the rotation axis. Further, a radial direction around the motor shaft 24 may simply be referred to as a radial direction, and a circumferential direction around the motor shaft 24 may simply be referred to as a circumferential direction. Further, a plan view in the axial direction (a plan view seen from the axial direction) may simply be referred to as a plan view.

As shown in FIGS. 1 to 7, the motor device 10 includes a motor 20 and a drive device 50. The motor device 10 may be referred to as a rotating electric machine including a drive device 50 (EDU: Electronic Drive Unit).

The motor 20 is a brushless permanent magnet type synchronous motor. The motor 20 has a housing 22, the motor shaft 24, bearings 26 and 28, a stator 30, a rotor 32, and a sensor magnet 34.

The housing 22 is made of a metal material such as iron and is provided in a substantially bottomed cylindrical shape. In the housing 22, an opening 220 located opposite to the bottom is closed by a sealing resin body 60 of the drive device 50. Other elements constituting the motor 20 are arranged in the accommodation space of the housing 22. The housing 22 holds the stator 30 and the rotor 32. The housing 22 corresponds to a holding member. The housing 22 (i.e., the motor device 10) is attached to a fixed node such as a timing chain case of the internal-combustion engine.

The housing 22 has a small diameter part 221, a large diameter part 222, a flange 223, and tabs 224. The small diameter part 221 is provided on a phase adjusting mechanism 8 side in the axial direction. The large diameter part 222 has a larger diameter than the small diameter part 221 and is provided on a drive device 50 side in the axial direction. The flange 223 is continuous with an end of the large diameter part 222 on the drive device 50 side and extends outward in the radial direction. The opening 220 is formed at an end of the large diameter part 222 on the drive device 50 side and is surrounded by the flange 223.

The tabs 224 extend radially outward from the flange 223 while being separated from each other in the circumferential direction. The housing 22 of the present embodiment has three tabs 224. Each of the plurality of tabs 224 is formed with a through hole 225 for screwing to a fixed node of the internal-combustion engine.

An opening 226 is formed near the center of the bottom of the housing 22. The opening 226 is provided closer to the phase adjusting mechanism 8 than the small diameter part 221, and the small diameter part 221 is provided at a position between the opening 226 and the large diameter part 222. The motor shaft 24 projects to the outside of the housing 22 through the opening 226 and is connected to the phase adjusting mechanism 8. The motor shaft 24 may be referred to as a shaft having a vertical rotation axis, as oriented in FIG. 1.

A through hole is formed at an end of the motor shaft 24 on the phase adjusting mechanism 8 side. A joint 38 for joining the motor shaft 24 to the phase adjusting mechanism 8 is fixed to the motor shaft 24, which is jointed to the mechanism 8 by inserting the pin 36 into a horizontal through hole (not shown) of the motor shaft 24. A seal member 40 such as an oil seal or packing is interposed at a position between an inner surface of the opening 226 and the motor shaft 24 in the housing 22.

The bearings 26 and 28 respectively support the motor shaft 24 for a rotation thereof in forward and reverse directions. In the axial direction, an outer ring of the bearing 26 on the phase adjusting mechanism 8 side is fixed to the inner surface of the small diameter part 221 of the housing 22, and an inner ring of the bearing 26 is fixed to the motor shaft 24. The bearing 26 is arranged almost entirely in the small diameter part 221 in the axial direction. One end of the motor shaft 24 and the bearing 28 are housed in a concave portion 601 of the sealing resin body 60. Specifically, an outer ring of the bearing 28 is fixed to a side surface of the concave portion 601, and an inner ring of the bearing 28 is fixed to the motor shaft 24. The bearing 28 holds one end of the motor shaft 24 apart from the sealing resin body 60.

The stator 30 is housed in the large diameter part 222 and held by the housing 22. The stator 30 is press-fitted and fixed to the large diameter part 222 of the housing 22, for example. The stator 30 is formed in a substantially cylindrical shape, and has a stator core 300 having a plurality of tooth portions, and a winding 302 wound around each tooth portion via a resin bobbin 301.

The stator core 300 is formed by stacking metal pieces. The plurality of tooth portions are arranged at equal intervals along the circumferential direction. The windings 302 corresponding to U, V, and W phases of the motor 20 are connected to each other via a terminal 303 for forming a neutral point. The winding 302 has terminal portions 302a and 302b, respectively. The terminal portions 302a of the respective phases are connected to the common terminal 303. The terminal portion 302b of each phase is inserted and mounted on a wiring board 52. The stator 30 generates a rotating magnetic field that acts on the permanent magnets of the rotor 32 by supplying a driving current to the winding 302.

The rotor 32 is rotatably housed inside the stator 30. The rotor 32 is formed in an annular plate shape that projects radially outward from the motor shaft 24, and is rotatable in the forward and reverse directions (clockwise and counterclockwise) around the vertical axis of the motor shaft 24. The rotor 32 has a rotor core 320, permanent magnets 321, and a fixing plate 322. The rotor core 320 is formed by stacking substantially disc-shaped core sheets. The rotor core 320 may be directly fixed to the motor shaft 24, or may be fixed via an engaging member. The permanent magnet 321 is provided so as to be rotatable integrally with the rotor core 320. The magnetic poles of the plurality of permanent magnets 321 are alternated in the circumferential direction. The fixing plate 322 is provided on both of the axial ends of the rotor core 320.

The sensor magnet 34 has an annular shape and is fixed to an outer peripheral edge of the surface of the rotor 32 on the drive device 50 side. The sensor magnet 34 rotates together with the rotor 32. The sensor magnet 34 is provided to detect a rotational position of the rotor 32, that is, a rotation angle of the motor 20. The sensor magnet 34 has N poles and S poles alternately provided at predetermined angles.

The drive device 50 is an electronic device including a circuit for driving the motor 20. The drive device 50 is positioned and fixed to the motor 20. The drive device 50 includes the wiring board 52, an electronic component 54, a Hall element 56, a connector 58, the sealing resin body 60, and the cover 62. The electronic component 54, the Hall element 56, and the connector 58 are mounted on the wiring board 52.

The wiring board 52 may be referred to as a printed board, or a printed circuit board. The wiring board 52 is formed by disposing wiring on a base member (substrate) made of an electrically-insulating material such as resin. A board thickness direction of the wiring board 52 is substantially parallel to the axial direction. The wiring board 52 has two surfaces in the board thickness direction, that is, two board surfaces, e.g., one surface 52a that is a surface on the motor 20 side and a back surface 52b that is a surface opposite to the one surface 52a. In other words, as shown in FIG. 1, the wiring board 52 has a vertical thickness, a bottom surface 52a, and a top surface 52b.

The electronic component 54 forms a circuit together with wiring. A plurality of electronic components 54 are mounted on the wiring board 52. The wiring board 52 on which the electronic component 54 is mounted may be referred to as a circuit board. The electronic component 54 is arranged on at least one of the one surface 52a and the back surface 52b. The electronic component 54 includes (see FIG. 6), for example, a switch 54a, a capacitor 54b, a coil 54c, a drive IC (not shown), and the like.

The switch 54a is a semiconductor element, which may be a MOSFET, an IGBT, etc. and constitutes an inverter. The inverter is a DC-AC conversion circuit that converts a DC voltage into a three-phase AC voltage and outputs it to the motor 20. The drive device 50 has six switches 54a that form an inverter (for a three phase motor). The drive device 50 has multiple capacitors 54b. At least one of the capacitors 54b is a smoothing capacitor that is connected in parallel to a DC power supply, and another of the capacitors 54b is a filter capacitor that removes power supply noise together with the coil 54c.

The Hall element 56 (see FIG. 1) detects the rotational position of the rotor 32 and outputs a detection signal to the drive IC. The Hall element 56 is arranged on the one surface (bottom surface) 52a of the wiring board 52 to face the sensor magnet 34. The drive device 50 has, for example, three Hall elements 56 provided at intervals of a predetermined rotation angle along the circumferential direction. The Hall element 56 corresponds to a magnetoelectric conversion element. The drive IC detects the rotational position of the rotor 32 based on the detection signal of the Hall element 56. The drive IC acquires a drive instruction of the motor 20 from an ECU (not shown) and drives each switch 54a, that is, performs ON drive and OFF drive based on the drive instruction and the rotational position. The drive IC is sometimes called a driver. “ECU” is an abbreviation of “Electronic Control Unit.”

In the present embodiment, the plurality of electronic components 54 including the drive IC are arranged on the one surface (bottom surface) 52a side. The electronic component 54 is also arranged around the Hall element 56 on the one surface 52a. Hereinafter, the electronic components 54 arranged around the Hall element 56 may be referred to as peripheral components 54d. The peripheral component 54d is arranged on the one surface 52a at a portion facing the sensor magnet 34. The peripheral component 54d is, for example, a resistor element. Further, some electronic components 54 (including the switch 54a, the capacitor 54b, and the coil 54c) are arranged on a back surface (top surface) 52b side of the wiring board 52.

The connector 58 electrically connects the drive device 50 and a device external to the motor device 10. The connector 58 electrically connects, for example, the above-mentioned ECU and the drive IC. Further, electric power is supplied to the drive device 50 from a DC voltage power source mounted on the vehicle via the connector 58.

The sealing resin body 60 seals at least a part of the electronic components 54 together with the wiring board 52. The drive device 50 is a resin-sealed electronic device. The sealing resin body 60 of the present embodiment seals all of the electronic components 54 mounted on the wiring board 52. The sealing resin body 60 seals the wiring board 52 almost entirely. The drive device 50 is a full-mold type electronic device.

The sealing resin body 60 has a substantially disc shape. The board thickness direction of the sealing resin body 60 is substantially parallel to the board thickness direction of the wiring board 52. The sealing resin body 60 also seals the Hall element 56. The sealing resin body 60 seals a part of the connector 58, specifically, a part including a connecting portion between the connector 58 and the wiring board 52. A portion of the connector 58 that is connected to an external device is exposed from the sealing resin body 60. The sealing resin body 60 has a main body 600 that seals the wiring board 52, the electronic component 54, the Hall element 56, and the connector 58. The main body 600 has a substantially disc shape.

The sealing resin body 60 has, as its surfaces, one surface (bottom surface) 60a that is a surface on the motor 20 side and a back surface (top surface) 60b that is a surface opposite to the one surface 60a. The main body 600 of the sealing resin body 60 has a bottomed concave portion 601 that has an opening in the one surface 60a. The concave portion 601 is a hole that does not penetrate the main body 600. As described above, one end of the motor shaft 24 and the bearing 28 are housed in the concave portion 601. The wiring board 52 is provided so as not to overlap the concave portion 601 in a plan view. The wiring board 52 is arranged to avoid the concave portion 601.

The main body 600 has through holes 602 and 603. The through holes 602 and 603 penetrate the sealing resin body 60 in the axial direction. The through holes 602 and 603 respectively have an opening in the one surface 60a and the back surface 60b. The through hole 602 is provided at a position that does not overlap the wiring board 52 in a plan view. The terminal 303 is arranged in the through hole 602. Through the through hole 602, the connecting portion between the terminal portion 302a of the winding 302 and the terminal 303 is exposed from the sealing resin body 60.

The through hole 603 is provided at a position overlapping the wiring board 52 in a plan view. The terminal portion 302b of the winding 302 is arranged in the through hole 603. Through the through hole 603, the connection portion (i.e., a solder joint portion) between the terminal portion 302b of the winding 302 and the wiring board 52 is exposed from the sealing resin body 60.

The sealing resin body 60 (including the main body 600) is arranged to close the opening 220 of the housing 22. The main body 600 functions as a case of the motor 20 together with the housing 22. A seal member (not shown) is interposed at a position between the main body 600 of the sealing resin body 60 and the flange 223 of the housing 22. The sealing resin body 60 functions as a case of the drive device 50 together with the cover 62. A seal member (not shown) is interposed at a position between the main body 600 of the sealing resin body 60 and a main body 620 of the cover 62. The seal member is interposed, for example, at the outer peripheral edge. The sealing resin body 60 functions as a case of the motor device 10 together with the housing 22 and the cover 62.

The sealing resin body 60 has a tab 604 that extends radially outward from the main body 600. The sealing resin body 60 has the same number of tabs 604 as the tabs 224. A through hole 605 is formed in each of the tabs 604. The tab 604 and the through hole 605 overlap the tab 224 and the through hole 225 of the housing 22 in a state where the motor 20 and the drive device 50 are respectively positioned to each other. The through hole 605 is provided by an inner wall of a collar 606 inserted into the sealing resin body 60, which is a tubular member made of metal, for example.

The cover 62 is made of a metal material such as iron and is provided in a substantially disc shape. The cover 62 is arranged on the back surface 60b side of the sealing resin body 60. The cover 62 has the main body 620 and a tab 621. The (cover) main body 620 covers the (resin) main body 600 of the sealing resin body 60. The tab 621 extends radially outward from the main body 620. The cover 62 has the same number of tabs 621 as the tabs 604. A through hole 622 is formed in each of the tabs 621. In the positioned state, the tab 621 and the through hole 622 of the cover 62 overlap the tab 604 and the through hole 605 of the sealing resin body 60. Therefore, in the positioned state, the tab 621 of the cover 62 overlaps the tab 224 of the housing 22 via the tab 604 of the sealing resin body 60. The through hole 622 of the cover 62 overlaps the through hole 225 of the housing 22 via the through hole 605 of the sealing resin body 60. For example, a bolt 70 is inserted through the through holes 622, 605, 225, and the motor device 10 is fixed to the fixed node (e.g., the chain case).

### Positioning Structure

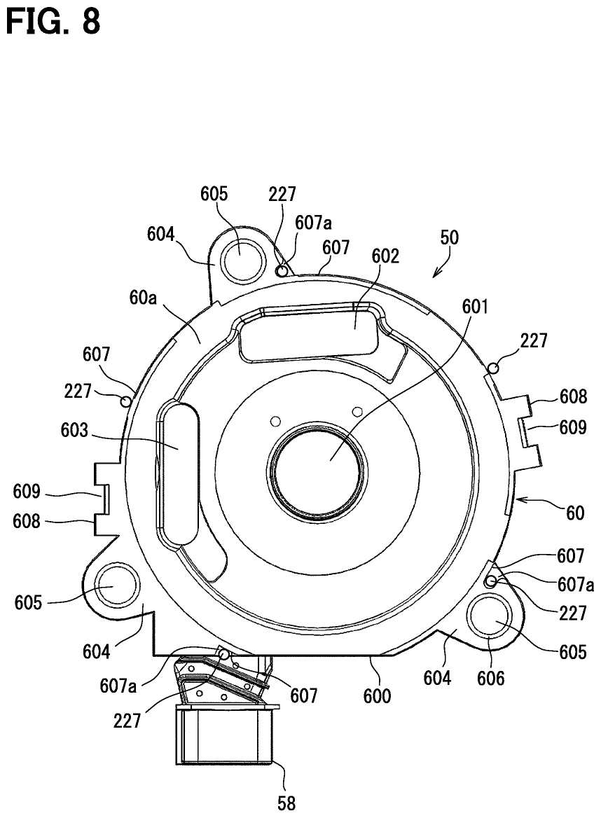

Next, a positioning structure between the housing 22 and the sealing resin body 60, that is, a positioning structure between the motor 20 and the drive device 50 will be described with reference to FIGS. 2, 3, 4, 7, and 8. FIG. 8 is a plan view of the drive device 50 as seen from the motor 20 side. In FIG. 8, an inlay boss 227 of the housing 22 is also shown in order to clarify the positioning structure. The inlay boss 227 may also be understood as something like a spigot protrusion.

The housing 22 has inlay bosses 227 on the flange 223. The plurality of inlay bosses 227 axially protrude from the surface of the flange 223 on the drive device 50 side. The inlay bosses 227 are provided along the circumferential direction. The inlay bosses 227 are provided on the same virtual circumference. The inlay bosses 227 are provided in a circumferentially dispersed manner to surround the motor shaft 24. The housing 22 of the present embodiment has five inlay bosses 227. The inlay boss 227 has a substantially columnar shape. The cross-sectional shape of the inlay boss 227 orthogonal to the axial direction is substantially circular.

The housing 22 has caulking protrusions 228 on the flange 223. The caulking protrusion 228 protrudes radially outward from the outer peripheral edge of the flange 223, and is bent so that its tip end faces the drive device 50. The tip of the caulking protrusion 228 is bifurcated.

The sealing resin body 60 has an inlay wall surface 607 at the outer peripheral end of the main body 600. The inlay wall surface 607 has an annular shape coaxial with the motor shaft 24. The inlay wall surface 607 is extended along the circumferential direction. The inlay structure is formed by fitting a inlay bosses 227 to the inlay wall surface 607, thereby the housing 22 and the sealing resin body 60 are positioned in the radial direction. As for the inlay wall surface 607, a molding surface of the sealing resin body 60 may be used as the inlay wall surface 607, or the inlay wall surface 607 may be formed by cutting the sealing resin body 60 after molding. By the cutting process, the surface accuracy, and thus the positioning accuracy can be improved.

The sealing resin body 60 has recesses 607a. The inlay wall surface 607 is provided as a part of a wall surface defining the recesses 607a. The inlay wall surface 607 forms an inner surface of each recess 607a. The sealing resin body 60 has three recesses 607a formed along the circumferential direction. The recess 607a is formed at a root of the tab 604 at the outer peripheral edge of the main body 600.

The sealing resin body 60 has a fixing part 608 at the outer peripheral edge of the main body 600. The fixing part 608 is provided with a locking recess 609 that penetrates in the axial direction and opens outward in the radial direction. The fixing part 608 is provided to sandwich the locking recess 609 in the circumferential direction. The caulking protrusion 228 is caulked and fixed to the fixing part 608 so that the bifurcated branched portions (two tips) stay respectively in a pressed state against the fixing part 608 in the locking recess 609. The inlay wall surface 607 and the fixing part 608 of the sealing resin body 60 correspond to a positioner with respect to the housing 22.

### Summary of First Embodiment

The drive device 50 of the present embodiment includes the sealing resin body 60 that seals the wiring board 52 and the electronic component 54. The sealing resin body 60 has the inlay wall surface 607 extending along the circumferential direction. The housing 22 of the motor 20 has a plurality of inlay bosses 227 provided along the circumferential direction. The inlay structure is formed by fitting the inlay protrusions 227 to the inlay wall surface 607. As a result, the housing 22 and the sealing resin body 60, and thus the motor 20 and the drive device 50 can be positioned in the radial direction.

Further, the sealing resin body 60 has the fixing part 608, and the housing 22 has the caulking protrusion 228. By caulking the caulking protrusion 228 to the fixing part 608, the housing 22 and the sealing resin body 60, and thus the motor 20 and the drive device 50 can be positioned in the circumferential direction.

As described above, by using the inlay wall surface 607 and the fixing part 608 of the sealing resin body 60, and by using the inlay boss 227 and the caulking protrusion 228 of the housing 22, the motor 20 and the drive device 50 are positioned in the radial direction and the circumferential direction, respectively. Note that the caulking structure enables positioning in the axial direction as well.

The Hall element 56 is positioned with respect to the sensor magnet 34 via the wiring board 52, the sealing resin body 60, and the housing 22. The positioning structure described above can reduce the number of elements interposed at a position between the Hall element 56 and the sensor magnet 34. As a result, the Hall element 56 can be accurately positioned with respect to the sensor magnet 34, and thus the rotation angle of the motor 20 can be accurately detected. Since the rotation angle of the motor 20 can be accurately detected, the output of the motor 20 can be improved.

The Hall element 56 may be not sealed by the sealing resin body 60. That is, the Hall element 56 may be exposed from the sealing resin body 60. The Hall element 56 of the present embodiment is sealed by the sealing resin body 60. Since the sealing resin body 60 is an insulator, a clearance for suppressing a short circuit is not required between the Hall element 56 and the metal base (not shown, and not used in these embodiments) unlike the configuration using a metal base as a case. Therefore, the peripheral component 54d (i.e., the electronic component 54) can be arranged around the Hall element 56.

If the peripheral component 54d is applied to the configuration including the metal base (not shown), the metal base must be arranged to avoid the peripheral component 54d in the axial direction. As a result, the sensor magnet 34 moves away from the Hall element 56. In the present embodiment, since the metal base is dispensed, the sensor magnet 34 can be brought close to the Hall element 56 in the axial direction. Thus, the rotation angle of the motor 20 can be detected more accurately, and the output of the motor 20 can be further improved. Moreover, the mounting density of the electronic components 54 on the wiring board 52 can be increased by disposing the peripheral components 54d thereon. As a result, the size of the wiring board 52 can be reduced.

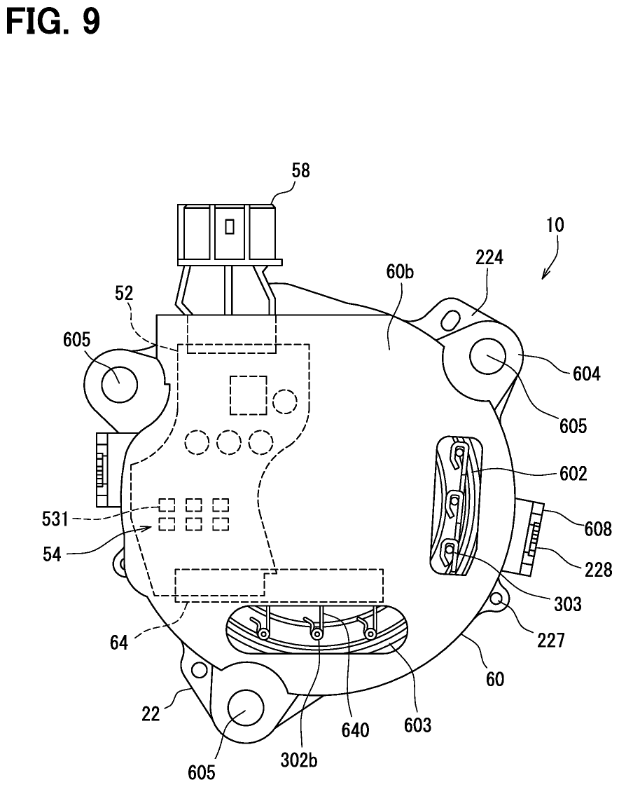

FIG. 9 is a plan view showing a modified example of the motor device 10, and corresponds to FIG. 6. In FIG. 9, for the sake of convenience, the cover 62 is omitted, and of the elements of the motor 20 exposed from the through hole 602, only the proximity of the terminal 303 is shown. In the modified example, a (optional) contact 64 for a connection to the motor 20 is mounted on the wiring board 52. A part of the contact 64 is sealed by the sealing resin body 60. A terminal 640 of the contact 64 projects into the through hole 603 and is connected to the terminal portion 302b of the winding 302. In such way, the wiring board 52 and the winding 302 may be connected via the contact 64.

When the contact 64 is used, the contact 64 may be deformed by heat when molding the sealing resin body 60 or by an external force from a molding die or the like. That is, the position of the terminal 640 may be displaced with respect to the terminal portion 302b. On the other hand, in the present embodiment, the terminal portion 302b of the winding 302 is inserted and mounted on the wiring board 52. As described above, since the contact 64 is not used, the connection reliability between the winding 302 and the wiring board 52 can be improved.

The connector 58 may be not sealed by the sealing resin body 60. That is, the entire connector 58 may be exposed from the sealing resin body 60. In the present embodiment, a part of the connector 58 is sealed by the sealing resin body 60. As a result, it is possible to increase (i) the strength of the connector 58 against pulling when a connector of the external device is fitted and (ii) the strength against vibration acting on the connector 58 via the external device.

The sealing resin body 60 may have no tab 604. The sealing resin body 60 of the present embodiment has the tab 604. The sealing resin body 60 has the inlay wall surface 607 and the fixing part 608 that are a positioner for the housing 22, respectively, and the tab 604 that serves as a device for fixing the sealing resin body 60 to the vehicle. As a result, the positioning accuracy between the center of a cam of the internal-combustion engine and the center of the motor shaft 24 of the motor 20 can be improved.

The sealing resin body 60 integrally seals the wiring board 52 and the electronic component 54 mounted on the wiring board 52. Such a sealing eliminates the need for a fastening member (for example, a screw) for fixing the electronic component 54 onto the wiring board 52, a vibration resistant adhesive for improving the vibration resistance of the electronic component 54, and the like. Further, since the wiring board 52 is fixed and the sealing resin body 60 that functions as a case seals the connector 58, a seal member between the connector 58 and the case can be eliminated.

### Other Embodiments

The disclosure in the specification and drawings etc. is not limited to the exemplified embodiment. The present disclosure encompasses the illustrated embodiments and modifications based on the embodiments by those skilled in the art. For example, the present disclosure is not limited to the combinations of parts and/or elements shown in the embodiments. The present disclosure may be implemented in various combinations. The present disclosure may have additional parts that may be added to the embodiment. The present disclosure may allow omissions of parts and/or elements of the embodiments. The present disclosure may allow replacement or combination of components, elements between one embodiment and the other. The technical scope of the present disclosure is not limited to the description of the embodiments. It is to be understood that some of the technical scopes of the present disclosure are shown by the description of the claims, and further include meanings equivalent to the description of the claims and all modifications within the scope.

The present disclosure in the specification, drawings and the like is not limited by the description of the claims. The present disclosure in the specification, the drawings, and the like encompasses the technical ideas described in the claims, and further extend to a wider variety of technical ideas than those in the claims. Therefore, various technical ideas can be extracted from the present disclosure of the specification, the drawings and the like without being limited to the description of the claims.

When an element or layer is referred to as “above,” “coupled,” “connected to,” or “bonded to,” it refers to other elements or layers. Thus, there may be a direct connection, a connection, or a bond on top, and there may be intervening elements or layers. In contrast, one element is mentioned as “directly over,” “directly coupled to,” “directly connected to,” or “directly coupled to” another element or layer, there are no intervening elements or layers. Other terms used to describe relationships between elements (e.g., “between” vs. “directly between”, “adjacent” vs. “directly adjacent”, etc.).) should similarly be interpreted. As used herein, the term “and/or” includes any and all combinations of one or more of the associated listed items.

The spatially relative terms “inside”, “outside”, “back”, “bottom”, “low”, “top”, “high”, etc. may be used to describe a relationship of one element or feature to other elements or features, typically as illustrated and the like. The spatial relative terms can be intended to encompass different orientations of the device during use or operation in addition to the orientation depicted in the drawing. For example, when the device in the drawing is flipped over, elements having been described as “below” or “right below” other elements or features may then be described as “above” other elements or features. Thus, the term “bottom” can encompass both an orientation of above and below. The device may be oriented in other directions (e.g., rotated 90 degrees or otherwise) and the spatially relative descriptors used herein may then be interpreted accordingly.

Use of the present motor device is not limited to the application to the motor device 10 and the valve timing adjusting device 6. A movable body described herein is not limited to a vehicle. An example in which the drive device 50 includes the cover 62 has been shown, but the drive device 50 is not limited thereto. It may be configured without the cover 62.

Although an example of the motor 20 having the inner rotor structure in which the rotor 32 is housed in the stator 30 is shown, the present disclosure is not limited thereto. It can also be applied to the motor 20 having an outer rotor structure.

An example of the Hall element 56 is shown as the magnetoelectric conversion element, but the present disclosure is not limited thereto. For example, a magnetoresistive effect element (MRE) may be adopted.

Although an example in which the sensor magnet 34 is attached to the rotor 32 has been shown, the present disclosure is not limited thereto. The sensor magnet 34 may be arranged to rotate together with the rotor 32 in order to detect the rotational position of the rotor 32. For example, the sensor magnet 34 may be fixed to a tip of the motor shaft 24, the mounting portion of the magnetoelectric conversion element (for example, MRE) on the wiring board 52 may be exposed in the concave portion 601, and the magnetoelectric conversion element may be arranged to face to the sensor magnet 34. In such manner, the wiring board 52 may be arranged so that the magnetoelectric conversion element faces the sensor magnet 34 attached to the rotating body of the motor shaft 24 and the rotor 32.

Although an example in which the holding member of the stator 30 and the rotor 32 also serves as the housing 22, the present disclosure is not limited thereto. The holding member may be provided separately from the housing 22.

What is claimed is:

1. A motor device comprising:
a motor including: a stator, a rotor, a housing holding the stator and the rotor, and a sensor magnet rotating with the rotor for a detection of a rotational position of the rotor; and
a drive device including: a wiring board facing the sensor magnet, an electronic components mounted on the wiring board, a magnetoelectric conversion element mounted on bottom side of the wiring board, and a sealing resin body at least partially sealing the wiring board, wherein
the sealing resin body has positioners positioning the sealing resin body and the holding member in a radial direction and in a circumferential direction which respectively center on a motor shaft rotation of the motor.

2. The motor device of claim 1, wherein
the sealing resin body seals the magnetoelectric conversion element together with the plurality of electronic components, and
the electronic components include a peripheral component arranged on a lower side of the wiring board at a location facing the sensor magnet.

3. The motor device of claim 1, wherein
the stator includes a winding having a terminal portion inserted and mounted on the wiring board, and
the sealing resin body has a through hole provided to overlap the terminal portion and a connection portion of the wiring board in a plan view in a direction along the rotation axis.

4. The motor device of claim 1, wherein
the drive device has a cover covering an upper surface of the sealing resin body,
wherein the cover is above the sealing resin body, and
wherein the sealing resin body is above the motor.

5. The motor device of claim 1, wherein
the drive device has a connector for external connection mounted on the wiring board, and
a first part of the connector is sealed by the sealing resin body and a second part of the connector is exposed from the sealing resin body.

6. The motor device of claim 1, wherein
the motor device is configured for use in a valve timing adjusting device for adjusting a valve timing of an internal-combustion engine of a movable body by rotation of the motor, and
the sealing resin body has a tab for fixing the motor device to the movable body.

7. A motor device comprising:
(A) a sealing resin body including:
(i) a first fixing part having a first locking recess,
(ii) a second fixing part having a second locking recess, and
(iii) a main body having an inlay wall surface substantially defining an outer circumference of the main body, and
(iv) a wiring board substantially sealed inside the main body;
(B) a stator located below the sealing resin body and including:
(i) a sensor magnet, and
(ii) a motor shaft having a vertical central axis; and
(C) a housing located below the stator and including:
(iii) a flange extending radially outward,
(iv) bosses extending upwardly from the flange and located in a circle, wherein the bosses are configured to restrict the inlay wall surface such that the outer circumference of the main body is centered at the vertical central axis, wherein the bosses include a first boss, a second boss, and a third boss;
(v) a first caulking protrusion extending upwardly from an outer edge of the flange and configured to lock into the first locking recess, and
(vi) a second caulking protrusion extending upwardly from the outer edge of the flange, located approximately opposite to the first caulking protrusion relative to the vertical central axis, and configured to lock into the second locking recess.

8. The motor device of claim 7, wherein the sealing resin body includes:
a first recess extending outwardly from the inlay wall surface, configured to receive the first boss, and configured to restrict the first boss from moving in a first rotational direction relative to the vertical central axis;
a second recess extending outwardly from the inlay wall surface, configured to receive the second boss, and configured to restrict the second boss from moving in an opposite rotational direction; and
a third recess extending outwardly from the inlay wall surface, configured to receive the third boss, and configured to restrict the third boss from moving in the opposite rotational direction.

9. The motor device of claim 8, wherein the sealing resin body further includes:
(v) a connector partially sealed by the main body, and partially extending substantially radially outwardly from the main body, and
(vi) a first tab, a second tab, and a third tab all extending radially outwardly from the main body portion, and all located approximately equidistantly around a perimeter of the main body, and
wherein the first recess is located in an edge of the first tab, and
wherein the second recess is located in an edge of the second tab.

10. The motor drive device of claim 9,
wherein the third recess is not located in the third tab.

11. The motor drive device of claim 10,
wherein the third recess is located below the connector.

12. The motor drive device of claim 7,
wherein the wiring board is oriented orthogonal to the vertical central axis,
wherein the wiring board is located radially outward from an upper bearing attached to the motor shaft,
wherein the wiring board includes a hall sensor extending downward from the wiring board, and
wherein the hall sensor is separated vertically from the sensor magnet by a thin portion of the main body.

13. The motor drive device of claim 12, further comprising:
(D) a cover located above the sealing resin body and including a concave portion opening downwardly.

14. The motor drive device of claim 13, wherein
the sealing resin body includes a convex upper surface portion configured to mate with the concave portion of the cover, and
the sealing resin body includes a substantially cylindrical recess configured to receive an upper bearing for the motor shaft.
